(19) United States
(12) Patent Application Publication
(10) Pub. No.: US 2017/0006445 A1
(43) Pub. Date: Jan. 5, 2017

(54) Systems, Methods, Circuits and Associated Software for Managing Communications from a Mobile Device to Other Parties and Retrieving and Managing Data Stored on the Mobile Device and Associated with the Communications to Other Parties

(71) Applicant: SILENT COMMUNICATION LTD., Tel Aviv (IL)

(72) Inventors: Zigmund Bluvband, Rishon Lezion (IL); Max Bluvband, Gibton (IL)

(21) Appl. No.: 15/201,524

(22) Filed: Jul. 4, 2016

Related U.S. Application Data
(63) Continuation-in-part of application No. 13/551,734, filed on Jul. 18, 2012.
Application No. 13/551,734 is a continuation of application No. 12/527,763, filed on Aug. 19, 2009, now Pat. No. 8,229,409.
Application No. 12/527,763 is a continuation-in-part of application No. 14/339,498, filed on Jul. 24, 2014.
Application No. 14/339,498 is a continuation of application No. 13/897,468, filed on May 20, 2013, now Pat. No. 8,792,874.
Application No. 13/897,468 is a continuation of application No. 12/777,528, filed on May 11, 2010, now Pat. No. 8,494,490.
(60) Provisional application No. 60/902,523, filed on Feb. 22, 2007.
(60) Provisional application No. 61/255,113, filed on Oct. 27, 2009.
(60) Provisional application No. 61/177,122, filed on May 11, 2009.

(51) Int. Cl. H04W 4/16; H04M 1/2745

(52) U.S. Cl. CPC H04W 4/16; H04M 1/274508; H04M 1/274575

(57) ABSTRACT

The present invention includes systems, methods, circuits and associated software for managing communications from a mobile device to other parties and retrieving and managing data stored on the mobile device and associated with the communications to other parties. The systems and methods of the present invention may further allow a calling party to make a called party to be aware of its intention to establish a call/communication session with it in one or more ways. According to the present invention a calling party may be automatically or manually offered alternatives to voice or other communication session. Further, many communication alternatives and other data for a party may be stored and organized in a local memory of a device and may be updated based on data retrieved from exterior sources, possibly from third party data storages accessed over a distributed data network, such as the internet.

### PRIORITY CLAIMS

This Application is a continuation in part of:

U.S. patent application Ser. No. 13/551,734, filed on Jul. 18, 2012 by the inventors of the present invention, titled “System and Method for Telephone Communication”, which, in turn, is a continuation of U.S. patent application Ser. No. 12/527,763, filed on Aug. 19, 2009 by the inventors of the present invention, titled “System and Method for Telephone Communication”, which, in turn, is a national stage entry of PCT/IL08/00236, filed on Feb. 24, 2008 by the inventors of the present invention, titled “System and Method for Telephone Communication”, which, in turn, claims priority from U.S. Provisional Patent Application No. 60/902,523, filed on Feb. 22, 2007 by the inventors of the present invention, titled “System and Method for Telephone Communication”;

All of which this Application claims priority from and each of which is hereby incorporated herein by reference in their entirety.

Accordingly, this Application claims priority from U.S. Provisional Patent Application No. 60/902,523, titled “System and Method for Telephone Communication” and filed on Feb. 22, 2007

This Application is further a continuation in part of:

U.S. patent application Ser. No. 14/339,498, filed by the inventors of the present invention on Jul. 24, 2014, titled “Systems, Methods, Circuits and Associated Software for Augmenting Contact Details Stored on a Communication Device with Data Relating to the Contact Contained on Social Networking Sites”, which, in turn, is a continuation of U.S. patent application Ser. No. 13/897,468, filed on May 20, 2013 by the inventors of the present invention, titled “Systems, Methods, Circuits and Associated Software for Augmenting Contact Details Stored on a Communication Device with Data Relating to the Contact Contained on Social Networking Sites”, which, in turn, is a continuation of U.S. patent application Ser. No. 12/777,528, filed on May 11, 2010 by the inventors of the present invention, titled “Method, circuit, system and application for providing messaging services”, which, in turn, claims priority from U.S. Provisional Patent Application No. 61/255,113, filed on Oct. 27, 2009 by the inventors of the present invention, titled “System, Method, Circuit and Associated Software for Augmenting Contact Details Stored on a Communication Device with Data Relating to the Contact Contained on Social Networking Sites” and U.S. Provisional Patent Application No. 61/177,122, filed on May 11, 2009 by the inventors of the present invention, titled “Method Circuit System and Application for Providing Messaging Services”;

All of which this Application claims priority from and each of which is hereby incorporated herein by reference in their entirety.

Accordingly, this Application also claims priority from:
a. U.S. Provisional Patent Application No. 61/255,113, titled “System, Method, Circuit and Associated Software for Augmenting Contact Details Stored on a Communication Device with Data Relating to the Contact Contained on Social Networking Sites” and filed on Oct. 27, 2009; and
b. U.S. Provisional Patent Application No. 61/177,122, titled “Method, Circuit, System and Application for providing messaging services” and filed on May 11, 2009.

### FIELD OF THE INVENTION

The present invention relates generally to the field of communication. More specifically, the present invention relates to systems, methods, circuits and associated software for managing communications from a mobile device to other parties and retrieving and managing data stored on the mobile device and associated with the communications to other parties.

### BACKGROUND

In modern times, mobile devices offer their users a plethora of communication methods and associated communication channels for communicating with other people. A communicating party, and/or his/her mobile device, however, are often times unaware of or simply not using other options he/she could use to try and contact the called/contacted party he tried to converse with. For these cases, where the calling/communicating party at one end tries to reach someone at another end and encounters different problems, there should be a solution that will identify for the calling/communicating party at least one other optional method to communicate with the called (or distant) party, depending on the features of the devices at both ends and on the features supported by the communication network. Some methods are known today to enable alternatives for a call that was not established yet, none of them teach the ability automated decision making for the enabling of dynamic continuation of the communication from the caller side according to given scenarios

A social networking site focuses on building online communities of people who share interests and/or activities, or who are interested in exploring the interests and activities of others. Most social network services are web based and provide a variety of ways for users to interact, such as e-mail, instant messaging and blog like services. Social networking has encouraged new ways to communicate and share information. Social networking websites are being used regularly by millions of people.

In general, social networking services allow users to create a profile for themselves, and can be broken down into two broad categories: internal social networking (ISN); and external social networking (ESN) sites such as MySpace, Facebook, Twitter and Bebo. Both types can increase the feeling of community among people. An ISN is a closed/private community that consists of a group of people within a company, association, society, education provider and organization or even an “invite only” group created by a user in an ESN. An ESN is open/public and available to all web users to communicate and are designed to attract advertisers. ESN's can be smaller specialized communities (i.e. linked by a single common interest e.g. TheSocialGolfer, ACountryLife.Com, Great Cooks Community) or they can be large generic social networking sites (e.g. MySpace, Facebook etc.).

However, whether specialized or generic there is commonality across the general approach of social networking sites. Users can upload a picture of themselves, create their ‘profile’, add a textual and/or graphical description of what they have in mind right now, post videos and more. Users can often be “friends” with other users. In most social networking services, both users must confirm that they are friends before they are linked and able to share information with each other. For example, if Alice lists Bob as a friend, then Bob would have to approve Alice's friend request before they are listed as friends. Some social networking sites have a “favorites” feature that does not need approval from the other user. Social networks usually have privacy controls that allow the user to choose who can view their profile or contact them, etc.

Some social networks have additional features, such as the ability to create groups that share common interests or affiliations, upload or stream live videos, and hold discussions in forums. Geosocial networking co-opts internet mapping services to organize user participation around geographic features and their attributes.

Lately, mobile social networking has become popular. In most mobile communities, mobile phone users can now create their own profiles, make friends, participate in chat rooms, create chat rooms, hold private conversations, share photos and videos, and share blogs by using their mobile phone. Mobile phone users are basically open to every option that someone sitting on the computer has. Some companies provide wireless services which allow their customers to build their own mobile community and brand it, but one of the most popular wireless services for social networking in North America is Facebook Mobile. Other companies provide new innovative features which extend the social networking experience into the real world.

Mobile social networking is currently accomplished using a web browser or via stand-alone applications for mobile devices. Both options operate independently of the other communication functions of the mobile device. Therefore, although these applications may allow a user to perform virtually any action on the social networks that could be performed on a home computer, they do not take advantage of the data contained on these sites in order to improve the other communication functions performed by the mobile device. Moreover, each application is site specific, communicating with only one social networking site. There is still a need for improved mobile social networking.

### SUMMARY OF THE INVENTION

The present invention includes systems, methods, circuits and associated software for managing communications from a mobile device to other parties and retrieving and managing data stored on the mobile device and associated with the communications to other parties. The systems and methods of the present invention may further allow a calling party to make a called party to be aware of its intention to establish a call/communication session with it in one or more ways. According to the present invention a calling party may be automatically or manually offered alternatives to voice or other communication session. Further, many communication alternatives and other data for a party may be stored and organized in a local memory of a device and may be updated based on data retrieved from exterior sources, possibly from third party data storages accessed over a distributed data network, such as the internet.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A & 1B: are schematic block diagrams illustrating two embodiments of systems according to the present invention;

FIG. 2: is a schematic flow diagram illustrating embodiments of the present invention available upon failure to establish voice call;

FIGS. 3 & 3A: are block diagrams of an exemplary system, method, circuit and associated software for augmenting contact details stored on a communication device, such as a mobile phone, with data relating to the contact contained on social networking sites, in accordance with some embodiments of the present invention.

FIG. 4: is a flowchart containing exemplary steps of operation of a system, method, circuit and associated software for augmenting contact details stored on a communication device, such as a mobile phone, with data relating to the contact contained on social networking sites, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

It should be understood that the accompanying drawings are presented solely to elucidate the following detailed description, are therefore, exemplary in nature and do not include all the possible permutations of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, including mobile phone or any mobile device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer or phone or any other computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention includes systems, methods, circuits and associated software for managing communications from a mobile device to other parties and retrieving and managing data stored on the mobile device and associated with the communications to other parties. The systems and methods of the present invention may further allow a calling party to make a called party to be aware of its intention to establish a call/communication session with it in one or more ways. According to the present invention a calling party may be automatically or manually offered alternatives to voice or other communication session. Further, many communication alternatives and other data for a party may be stored and organized in a local memory of a device and may be updated based on data retrieved from exterior sources, possibly from third party data storages accessed over a distributed data network, such as the internet.

The present invention further discloses methods and systems for enabling a calling party to better control the situation when a conversation session failed to be established (for example when the calling party is responded with waiting call signal, a no-answer signal, a redirection of the call to answering machine, a busy tone, a ‘wrong number’ announcement, a ‘network difficulty’ announcement, etc. or generally manage communication channels with other parties and associated data. For example, in case a calling party calls a called (distant) party phone, such as a mobile (or cellular) phone, and is responded by a ‘no answer’ signal, and may be even the outgoing message of the voice mail service has been activated and then the calling party decides not to leave a message. In such a case the system may automatically and/or manually offer the calling party to use an alternative service for connecting the called party, as will be described in details below. Other case may be when a calling party calls a mobile phone of a called party, and in case the called party is unavailable, such as it is within another communication session and the calling party receives a ‘call waiting’ signal, once the calling party terminates the intended session, it may be given an option to start an alternative communication link with the called party, as will be described in details below. Other cases may include any listing of communication channels and/or data associated with called parties.

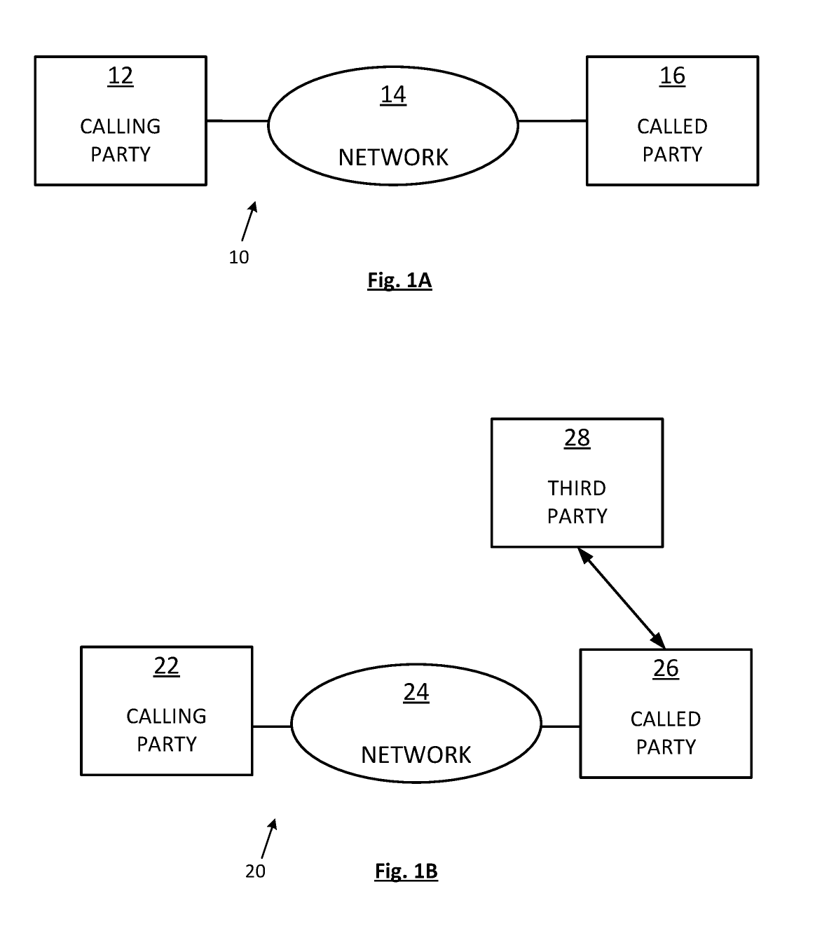

Attention is made to FIGS. 1A and 1B are schematic block diagrams illustrating two embodiments of systems 10 and 20, respectively, according to the present invention. System 10 may comprise a calling party 12 having an active connection to at least called party 16 via communication network 14. Calling party 12, 22 may be a cellular phone, a mobile phone, etc. Called party 16, 26 may be also a cellular phone, a mobile phone, etc. Network 14, 24 may be a cellular network (or more than one cellular network, as the case may be), a mixed network comprising two or more of cellular network, Internet Protocol (IP) based network, landline network, etc. in this application the term network may also comprise a network service provider and options offered by the network and the network service provider, such as signaling, etc. A third party equipment 28 may be any distant equipment being able to connect with called party 26, such as a remote global positioning system (GPS) device, remote equipment that may be activated from remote distance, etc.

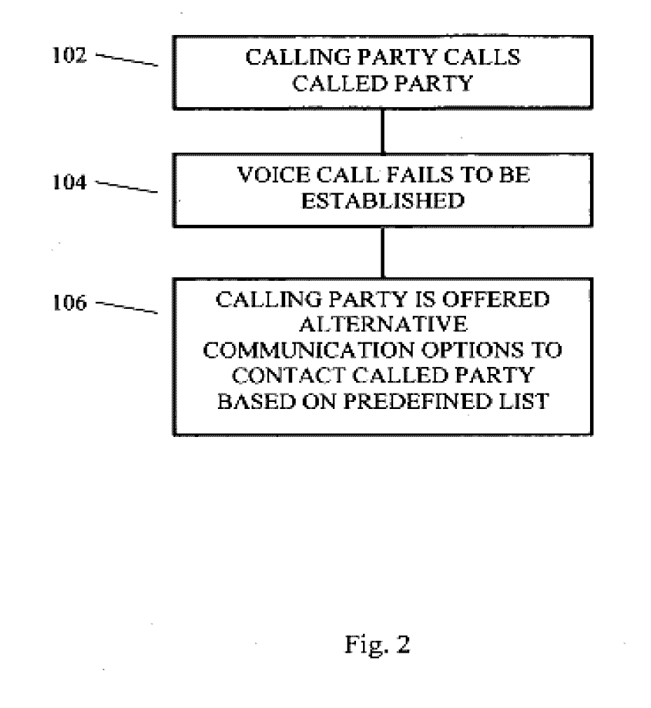

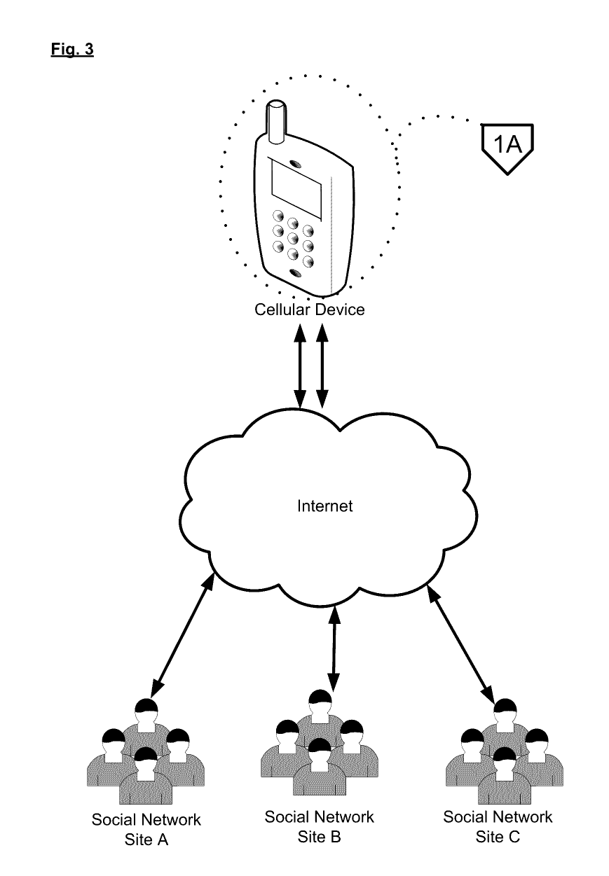

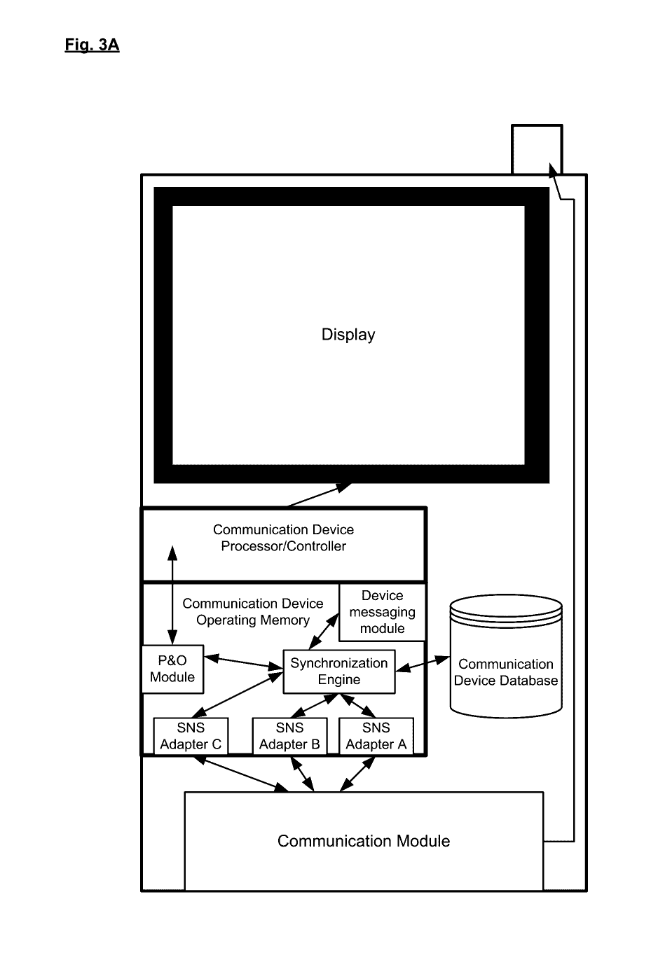

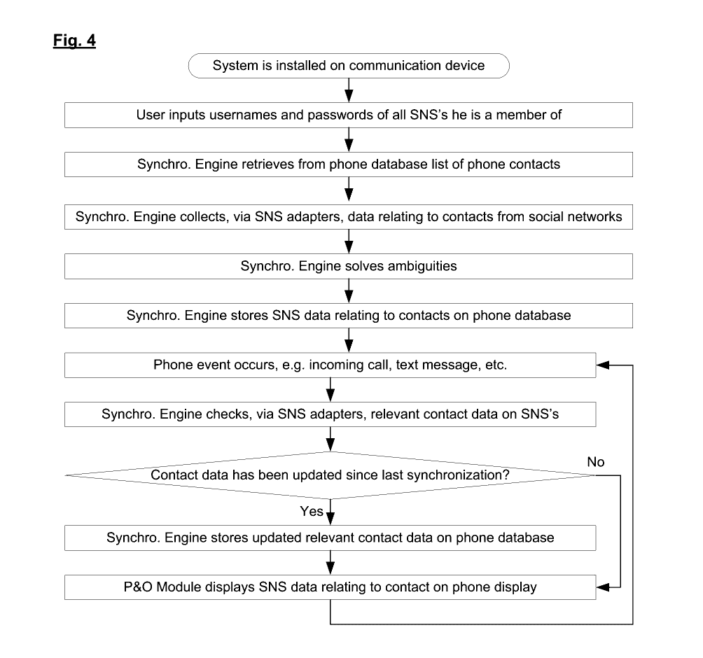

Attention is made now to FIG. 2, which is a schematic flow diagram illustrating embodiments of the present invention available to a calling party upon failure to establish voice call with a called party. Calling party 12, 22 may try to establish a voice call session with called party 16, 26 (block 102). Calling party 12, 22 may be equipped with a predefined list of alternative communication options with called party 16, 26, such as a short messaging service (SMS), a media messaging service (MMS) and the like. When calling party 12, 22 fails to establish an intended voice call session (block 104), such as when a busy tone' is signaled, or a ‘call waiting’ is signaled; or when called party 16, 26 is disconnected or out of service, etc., or when the user requests, the system and method of the present invention may offer calling party 12, 22 alternative communication options to contact called party 16, 26 based on a predefined list (block 106). The signals which are received from called party 16, 26 may symbolize the failure of establishment of a voice call and may activate in calling party 12, 22 a local service which automatically may invoke a menu, or any other manner of presenting options to the called party, which may list some or all of the alternative options for calling party 12, 22 to establish other communication channel with called party 16, 26, such as sending a SMS message, sending a MMS message, calling an alternative phone number (either an associated other cellular number, a landline number, etc.) and the like. This may ease on calling party 12, 22 to establish an alternative communication link with called party 16, 26 when called party 16, 26 is unavailable. The alternative communication links may be saved in a table-like arrangement at calling party 12, 22 or may alternatively be readily saved at one or more of service providers of network 14, 24 or, additionally or alternatively, be saved in a dedicated server connected to and available from network 14, 24.

The contacting details of the alternative communication links may be stored in a ‘contacts library’ that may be displayed or otherwise suggested to calling party 12, 22, for example using menu driven options that may be invoked automatically when the unavailability of called party 16, 26 has been identified. The contacts library may be constructed with appropriate pointers and indicators between contacts arranged in such a way to allow recommending and/or prioritizing entries in the list in order to start text/voice session called party 16, 26, using the pair-wise comparison method, Saati matrices, voting techniques, historical tracking statistics, etc. As an alternative or in parallel a fast, real time search in a network such as the Internet or other media may be started, in order to look for and load if found such a list of additional communication channels leading to called party 16, 26 such as phone numbers, ‘pointers’, ‘contacting addresses’, etc., that calling party 12, 22 may be interested to use for establishing alternative communication with. Equally, such searches may be performed in advance or at other defined timings.

In other words, according to some embodiments of the present invention, processing circuitry of a mobile device may be caused to: (1) identify data contained in distributed data networks relating to contacts stored on the mobile device, and (2) retrieve the data from the distributed data network and associate it with the given contact.

Thus, according to some embodiments, a mobile communication device may comprise: a display;

communication circuitry adapted to engage in voice and data communication with a base-station; non-volatile memory adapted to store one or more connection identifiers of third parties; and a controller and/or control-logic adapted to retrieve from the internet alternative/additional/parallel communication paths/channels identifiers/indicators of the third parties and/or any other data relating to the third parties.

For example, calling party 12, 22 calls called party 16, 26. A voice session is not established and a Voice mail outgoing message is played by called party 16, 26 (or on behalf of called party 16, 26) is sent in response with one of Call waiting/No answer/Busy tone, etc. Calling party 12, 22 is given an opportunity, within a predefined period of time, to select an alternative communication link through a menu driven offering to start, for example, a text messaging session with called party 16, 26 using, for example, SMS or any other messaging platform. The text session may be established to the same phone number, or to a number associated with called party 16, 26 as listed in the predefined list of alternative communication options described above, or any other number/numbers that may be associated with called party 16, 26.

According to some embodiments, identifying data contained in distributed data networks relating to contacts stored on the mobile device and retrieving the data to the mobile device to be associated with the given contact may include augmenting contact details stored on a communication device, such as a mobile phone, with data relating to the contact contained on social networking sites (hereby: “SNS”). According to some embodiments of the present invention, there may further be provided a synchronization engine (hereby: “SE”), which SE may be adapted to reside on the operating memory of a communication device, such as a cellular phone. The SE may be adapted to collect data from SNS's, via social network adapters, and to display and/or store the collected data on the communication device and may be further adapted to integrate the collected data into the operation of the communication device, which may include integrated usage of the information with any of the device's embedded functionalities.

According to some embodiments of the present invention, a SE may be installed on, or be otherwise functionally associated with a communication device. Upon initial instancement, the SE may be adapted to prompt the user to input the SNS's of which he is a member and his/her credentials (username, password, etc.) for access to each of the SNS's inputted. According to further embodiments of the present invention, the SE may be adapted to detect independently what SNS's a user is a member of. The SE may then access the user's profiles on the inputted SNS's using the credentials provided by the user. Subsequently, the SE may compare the contacts stored on the communication device to the user's contacts/“friends” on the SNS's to search for individual profiles on the SNS's that are associated with contacts stored on the communication device. The SE may be adapted to recognize corresponding profiles even in cases that the name is not spelled exactly the same or is otherwise slightly different from the details stored on the communication device regarding the specific contact. This may be performed using special heuristics that can perform a few types of comparisons and correlations that cover those cases where the contact name is not identical in the phone contact and in the SNS's. This algorithm may search for permutations on a specific name and/or may compare additional information in suspected cases, for example it may compare the associated e-mail or residential address as well as additional parameters. Once the SE has correlated a contact with a specific profile on a SNS, it may store a pointer/link to that profile for future updates of data, relating to the contact, from the SNS. According to yet further embodiments of the present invention, once the correlation between one or more contacts stored on the communication device and one or more profiles stored on one or more SNS's is established, the SE may be further adapted to allow a user to perform actions relating to the correlated contacts, on one or more SNS's, via the communication device and/or to use the contact list stored on the communication device while performing actions on a SNS.

According to further embodiments of the present invention, the SE may be further adapted to collect data relating to the corresponding contacts, such as the contact's homepage URL, birthday, spouse, company, title, phone #, e-mail and more from those contact's profiles on the SNS's and according to further embodiments of the present invention, may store the collected data on the communication device's database and/or on an exterior database, possibly associated with the provider of the SE, the provider of the communication device and/or the provider of the communication service.

According to further embodiments of the present invention the SE may be further adapted to update/augment the data associated with a specific contact on one or more SNS's based on data relating to that contact stored on the communication device and/or based on user request.

According to some embodiments of the present invention, the SE may communicate with the SNS's via SNS adapters, which SNS adapters may communicate with SNS's via application programming interfaces (hereby: “API”) provided by the SNS's. The SNS adapters may be adapted to translate communications from the SE into protocols used by the API's and vice versa. Each SNS adapter may be adapted to communicate with one or more SNS's and may be further adapted to optimize communications according to specific parameters, such as band width consumption. The SE may be adapted to aggregate and synchronize the data relating to each contact, collected from different SNS's, possibly through multiple SNS adapters.

According to further embodiments of the present invention, there may be provided a presentation and operation module (hereby: “P&O module”), which P&O module may be adapted to reside on the operating memory of a communication device or otherwise be functionally associated with a communication device. The P&O module may be adapted to communicate with the processor/controller of a communication device and to cause the processor/controller to present to a user data collected from SNS's, relating to a contact stored on the communication device's database. For example, the P&O module may display the contact's latest “profile picture” or “tag line”, from a social networking website (such as facebook), when the contact details are displayed. The P&O module may cause the processor/controller to present to a user data, collected from SNS's, relating to a contact, when the communication device is communicating with the contact, when a user accesses the contact's information, upon request and/or at any other time the contact's details are presented to the user. The P&O module may retrieve the data collected from SNS's relating to a contact directly from the communication device's database, an external database (in the event that the data is stored on an external database) and/or via the SE.

According to yet further embodiments of the present invention, the SE may be adapted to collect data relating to a contact, from SNS's, periodically, substantially continuously, when triggered by the user and/or upon the occurrence of an event involving the specific contact, such as if the specific contact calls the communication device. The SE may be adapted to recognize and collect only data that has been updated since the previous data collection performed by the SE. According to further embodiments of the present invention, the SE may collect data associated with certain contacts more often than others, based on predefined criteria, such as the frequency of communication with the contact (“frequently used”), the last time the contact was used by the communication device (“recently used”) and/or any other relevant distinction.

The present invention further includes methods, circuits, systems and applications for providing messaging services. According to some embodiments of the present invention, a VVM (Visual Voice Mail) or other messaging application may include server-side component(s) (network side components) and/or client-side software application component(s) installed on a Remote Device (Remote Device=mobile communication/computing device such as a cell phone, feature phone, Java phone, smart phone, pocket PC, etc.).

According to some embodiments of the present invention, the VVM client application or other messaging application may also access the list of contacts details stored on the remote device and correlate the origin of stored voice and/or text messages (e.g. the phone number from which the message originated) with matching contacts on the remote device. Accordingly, details relating to contacts, stored on the remote device, may be associated with correlating voice messages as metadata and may be displayed to the user along with the other metadata associated with the stored voice messages.

According to further embodiments of the present invention, the VVM client application or other messaging application may be further adapted to allow a user to access and utilize metadata associated with a voice message for other applications. For example, a user may be able to: (1) copy the details of the depositor/sender of a voicemail into his local contacts, (2) reply to the depositor/sender of a voicemail via sms, mms or direct call, (3) forward the voice message via email, etc.

According to further embodiments of the present invention, the VVM client application or other messaging application may be further adapted to communicate with additional service providers, such as advertising servers, social network servers, text transcription servers or any other relevant service provider. The VVM client application or other messaging application may communicate with these service providers via API's provided by said service providers and may include or be adapted to retrieve the appropriate protocols for these communications. The VVM client application or other messaging application may be adapted to retrieve from these service providers data relating to voicemails and/or text messages stored on the remote device, such as further contact details, and to associate this data with the relevant voice/text message. For example, the VVM client application or other messaging application may correlate data associated with a voice/text message, such as the origin, with data contained in a profile stored on a social network server and may be adapted to associate other data contained in the same profile, such as a profile picture, with the specific voice/text message. Similarly, a contact name associated with a voicemail/SMS may be correlated with a facebook profile, for example. In this fashion, a user may be displayed a current profile picture from facebook of the depositor of a voicemail/SMS/message, aside the listing of the stored voicemail/message.

For a detailed description of the interfacing between a communication application client application and social networking service providers please refer to: U.S. Provisional Patent Application No. 61/255,113, filed by the inventors of the present invention, Titled “System, Method Circuit and Associated Software for Augmenting Contact Details Stored on a Communication Device with Data Relating to the Contact Contained on Social Networking Sites”. The '113 application is hereby incorporated by reference in its entirety into the present description.

According to some embodiments of the present invention, applications described herein may be preloaded (ROM, UDA or MMC) on a remote device when a user acquires it. Applications described herein may be preloaded by the cellular network operator as an application or preloaded by the remote device manufacturer as part of the remote device delivered to the operator.

According to further embodiments of the present invention, applications described herein may be installed on an existing remote device, “Over The Air” (OTA), i.e. via remote communication or by any other media, such as via a usb cable. When being installed OTA the user may receive a link via SMS to download the applications described herein, may be directed to install the applications through the operator web/WAP portal, or by any other suitable means. The applications described herein may be pre-programmed with instructions on how to install themselves on a remote device including another or a previous version of the application being installed.

The present invention can be practiced by employing conventional tools, methodology and components. Accordingly, the details of any such tool, component and methodology are not set forth herein in detail. In the previous descriptions, numerous specific details are set forth, in order to provide a thorough understanding of the present invention. However, it should be recognized that the present invention may be practiced without resorting to the details specifically set forth.

It should also be understood by one of skill in the art that some of the functions described as being performed by a specific component of the system may be performed by a different component of the system in other embodiments of this invention.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A mobile communication device comprising:
a display;
communication circuitry adapted to engage in voice and data communication with a base-station;
a processor functionally associated with said communication circuitry;
non-volatile memory adapted to store one or more contact details of a first party; and
an operating system including control-logic configured to cause said processor to:
a) search for details relating to one or more additional communication channels associated with the first party, which details are accessible through the Internet; and
b) retrieve, through the Internet, the details relating to one or more additional communication channels associated with the first party and found by said processor in said search.

2. The device according to claim 1, wherein the one or more additional communication channels include a phone number.

3. The device according to claim 1, wherein the one or more additional communication channels include an address.

4. The device according to claim 1, wherein said control logic is further configured to cause said processor to store the retrieved details in said non-volatile memory in a list of communication channels associated with the first party.

5. The device according to claim 4, wherein said control logic is further configured to cause said processor to offer the one or more additional communication channels in a menu of alternative communication channels relating to the first party.

6. The device according to claim 4, wherein the list of communication channels associated with the first party is arranged based on a historical statistics of entries in the list.

7. A method of managing lists of communication channels, relating to a first party, upon a mobile communication device, said method comprising:
storing in a non-volatile memory of the mobile communication device, one or more contact details of the first party;
using a processor and internet communication circuitry of the mobile communication device to search for details relating to one or more additional communication channels associated with the first party, which details are accessible through the Internet, and
using the processor and internet communication circuitry of the mobile communication device to retrieve through the Internet, the details relating to one or more additional communication channels associated with the first party and found by said processor in said search.

8. The method according to claim 7, wherein the one or more additional communication channels include a phone number.

9. The method according to claim 7, wherein the one or more additional communication channels include an address.

10. The method according to claim 7, further comprising storing the retrieved details in the non-volatile memory in a list including communication channels associated with the first party.

11. The method according to claim 7, further comprising offering the one or more additional communication channels in a menu of alternative communication channels relating to the first party.

12. A mobile communication device comprising:
communication circuitry adapted to connect a processor of said mobile communication device to the Internet;
non-volatile memory adapted to store a contacts library including one or more contact details or identifiers of a first party; and
an operating system including control-logic configured to cause said processor to:
(1) search via the Internet for data related to the first party, and
(2) retrieve, via the Internet, the data related to the first party and found by said processor in said search.

13. The device according to claim 12, wherein the data includes a phone number.

14. The device according to claim 12, wherein the data includes an address.

15. The device according to claim 12, wherein said control logic is further configured to cause said processor to store the retrieved data in said non-volatile memory in a list associated with the first party.

16. The device according to claim 15, wherein said control logic is further configured to cause said processor to present the retrieved data in a menu of communication channels relating to the first party.

17. The device according to claim 12, wherein said data is retrieved from a social networking site.

18. The device according to claim 15, wherein the list associated with the first party is arranged based on a historical statistics of entries in the list.

19. The device according to claim 17, wherein the data includes a picture.

20. The device according to claim 17, wherein said operating system is configured to cause said processor to automatically and independently:
a) search for details relating to one or more additional communication channels associated with the first party, which details are accessible through the Internet; and
b) retrieve, through the Internet, the details relating to one or more additional communication channels associated with the first party and found by said processor in said search.
